(19) United States
(12) Patent Application Publication
(10) Pub. No.: US 2006/0205456 A1
(43) Pub. Date: Sep. 14, 2006

(54) Video games and add-on features

(76) Inventors: William G. Bentz, Laurel, MD (US); Gonzalo F. Valdes JR., Tampa, FL (US)

Correspondence Address: William G. Bentz, 8106 Shannon's Alley, Laurel, MD, 20724, US

(21) Appl. No.: 11/141,948

(22) Filed: Jun. 2, 2005

Related U.S. Application Data
(63) Continuation-in-part of application No. 11/120,936, filed on May 4, 2005.
Application No. 11/120,936 is a continuation-in-part of application No. 11/078,664, filed on Mar. 14, 2005.

(51) Int. Cl. A63F 13/00

(52) U.S. Cl. 463/1

(57) ABSTRACT

One embodiment of a method may display, through a store, information identifying at least an add-on feature. The method may raise funds for charity by at least selling and/or renting, through the store, the add-on feature to import into at least a video game.

This application is a continuation-in-part of Ser. No. 11/120,936, filed May 4, 2005, which is a continuation-in-part of Ser. No. 11/078,664, filed Mar. 14, 2005.

### FIELD OF THE INVENTION

The present invention relates in general to video games and/or add-on features for video games.

### DESCRIPTION OF BACKGROUND INFORMATION

The video game industry is a growing multi billion dollar industry. Electronic Arts' Madden NFL Football has been recognized as the most popular sports video game ever. Electronic Arts has compared the Madden NFL Football game to an ever-evolving novel, with a new chapter being written every year. Electronic Arts, as a leading developer and publisher of interactive entertainment software, has emphasized the need to continue to take a video game and its users to new heights. Accordingly, new ways are needed to enhance a user's game experience.

### BRIEF DESCRIPTION OF THE DRAWINGS

In the drawings, like reference numerals represent similar parts of the illustrated embodiments of the present invention throughout the several views and wherein:

FIGS. 1A-1E and 2-12 depict exemplary embodiments of methods; and

FIGS. 13-15 depict exemplary games.

### DETAILED DESCRIPTION

One embodiment of a method may provide, through a first video game, one or more features (e.g., athletes and/or team rosters, for example, including the one or more athletes). The method may play, through a second video game, a game with at least the one or more features (e.g., athletes) by importing the one or more features (e.g., athletes and/or team rosters) from the first video game to the second video game. The first video game and the second video game may be of different sports, sports leagues and/or categories.

The method may allow video game companies such as, for example, Electronic Arts to integrate some and/or all of their sports games and/or other category of games. The method may allow garners to select, for themselves, individual features (e.g., character(s), roster(s), song(s), etc.), which they may like and/or be interested in, to import from a first video game (e.g., and/or other) to at least a second video game, so as to play the second video game with at least the features. The method may also allow garners to try to determine (e.g., year after year) who is the best athlete and/or team in the world, for example, by playing one or more sports video games with athletes and/or teams outside their specialties.

Another embodiment of the method may display information identifying at least (i) a plurality of video games (e.g., and others) and (ii) a plurality of characters, rosters and/or other features (e.g., and others). The method may individually sell and/or rent the video games, and individually sell and/or rent, separate from the video games, the characters, rosters and/or other features to import into one or more of the video games. The method may provide (e.g., mail and/or download) the characters, rosters and/or other features to import into the one or more of the video games. The method may charge for the characters, rosters and/or other features on a per character, roster and/or feature basis, for example, plus provide personal use rights.

Each of the characters, rosters and/or other features may be of a first category of video games, and each of the video games may be of a second category of video games, where the first category and the second category may be different categories. Each of the characters, rosters and/or other features may also be of a first video game of a first sport, and the one or more of the video games may include a second video game of a second sport, where the first sport and the second sport may be different sports.

In addition, the characters, rosters and/or other features may include a plurality of first characters, rosters and/or other features and a plurality of second characters, rosters and/or other features. Each of the plurality of first characters, rosters and/or other features may be of a first category of video games, and each of the plurality of second characters, rosters and/or other features may be of a second category of video games, where the first category and the second category may be different categories. The one or more of the video games may fall under one of (i) the first category of video games and (ii) the second category of video games. The one or more of the video games, for example, may include a sports video game.

Further, the characters, rosters and/or other features may include a plurality of first characters, rosters and/or other features, a plurality of second characters, rosters and/or other features and a plurality of third characters, rosters and/or other features. Each of the plurality of first characters, rosters and/or other features may be of a first video game of a first sport, each of the plurality of second characters, rosters and/or other features may be of a second video game of a second sport, and each of the plurality of third characters, rosters and/or other features may be of a third video game of a third sport, where each of the first sport, the second sport and the third sport may be different sports. For example, the first sport may be football, the second sport may be basketball, and the third sport may be baseball. The one or more of the video games may include a fourth video game of a fourth sport, where the fourth sport may be different than each of the first sport, the second sport and the third sport. The fourth sport may be football, basketball or baseball.

The method may then provide video game companies a way to add new revenue streams and, also, a way to add new dimensions to their video games. The method, for example, may allow gamers to research, preview, buy, rent, trade, download and/or recommend individual characters, rosters and/or other features (e.g., of and/or for one or more video games and/or others) they like and want to own to import, for example, into video games (e.g., of different titles, leagues, sports and/or categories), so as to play the video games with at least the individual characters, rosters and/or other features.

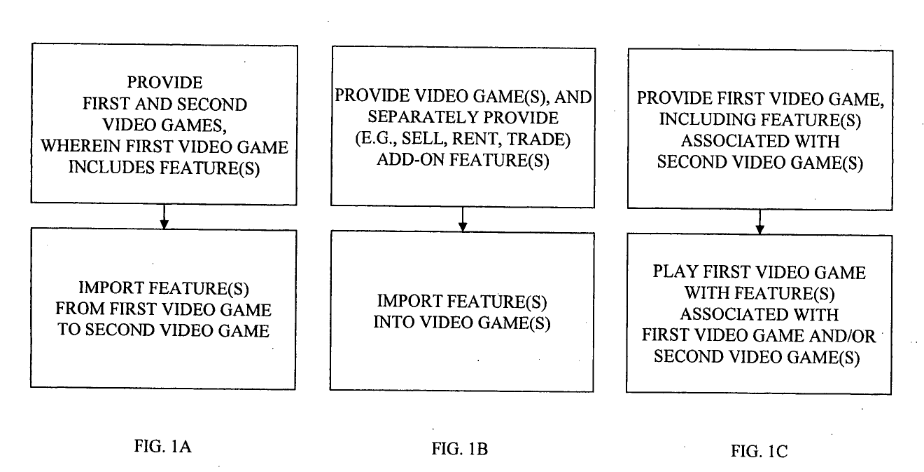

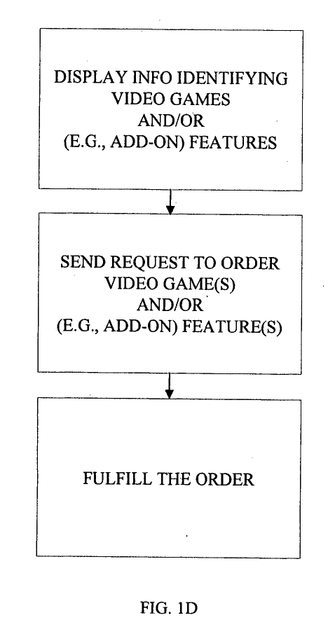

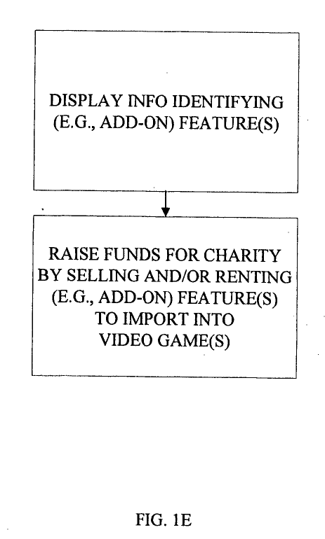

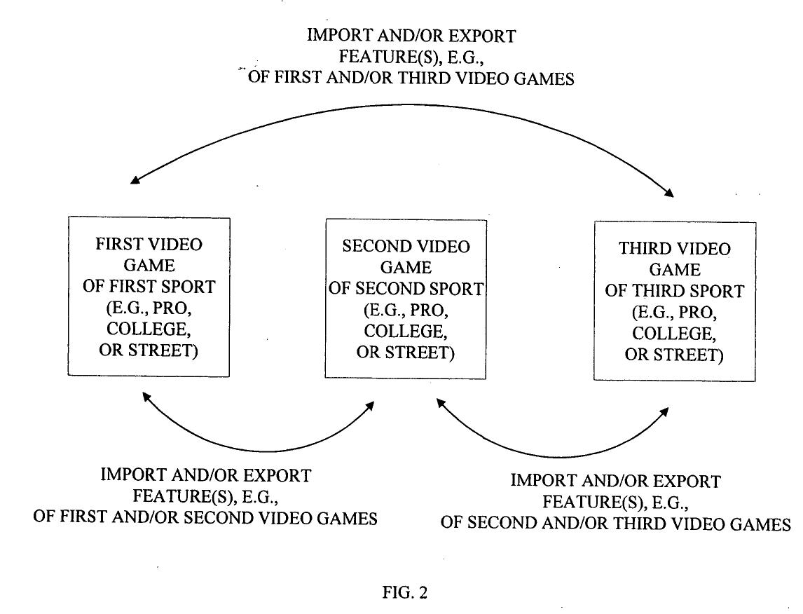

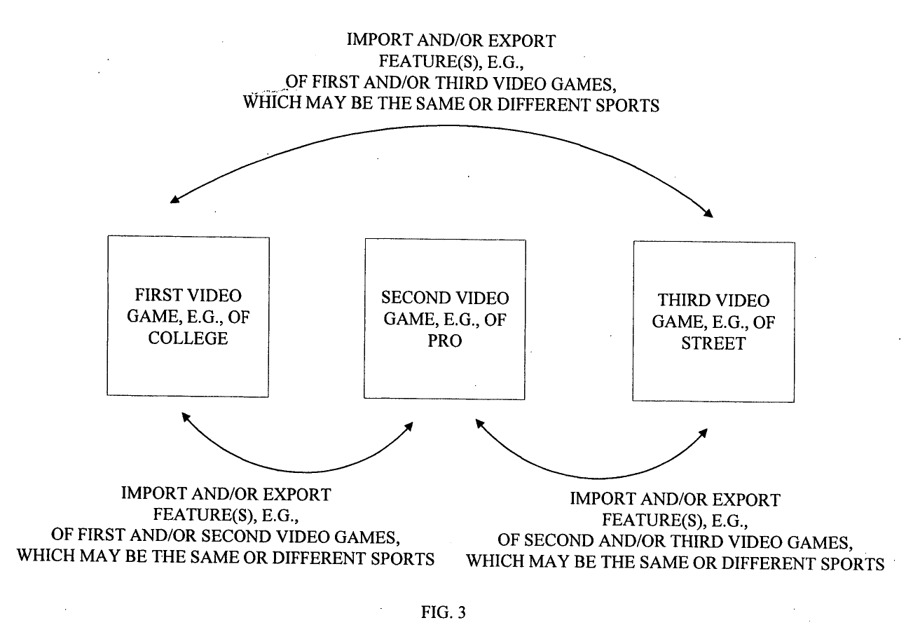

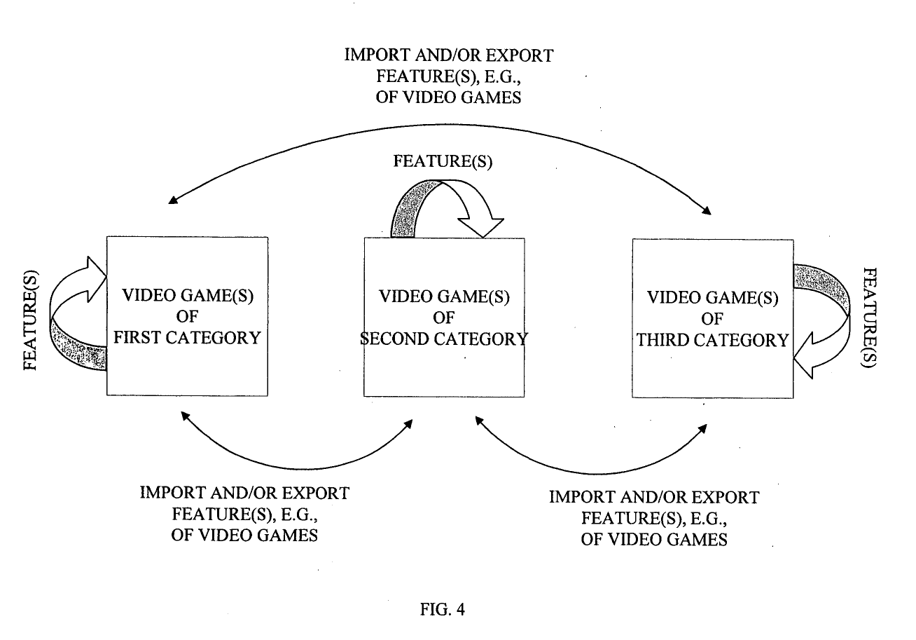

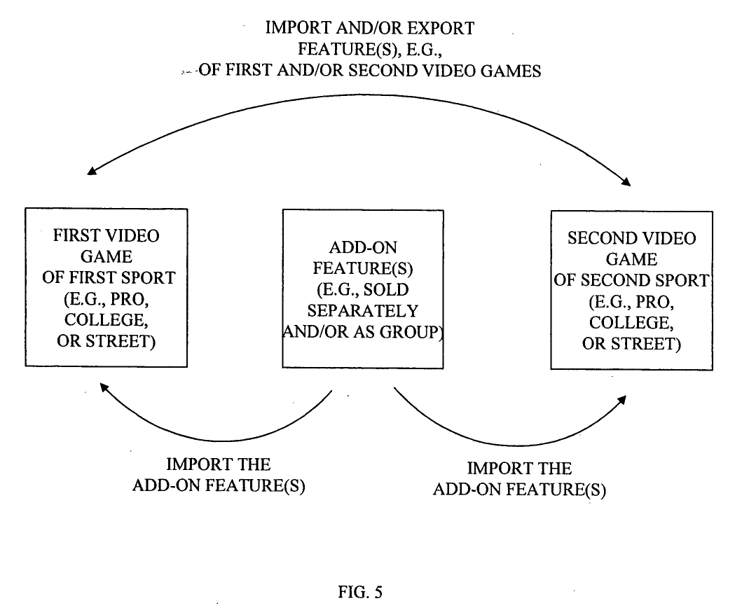

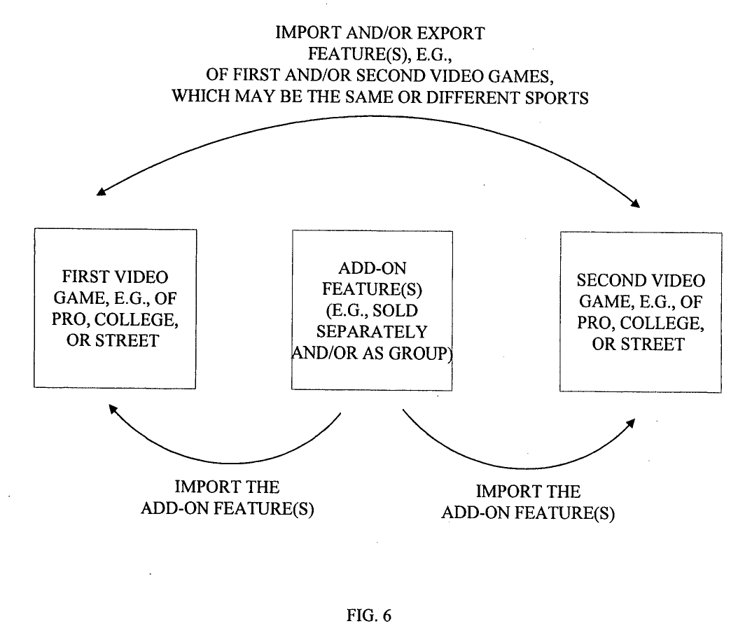

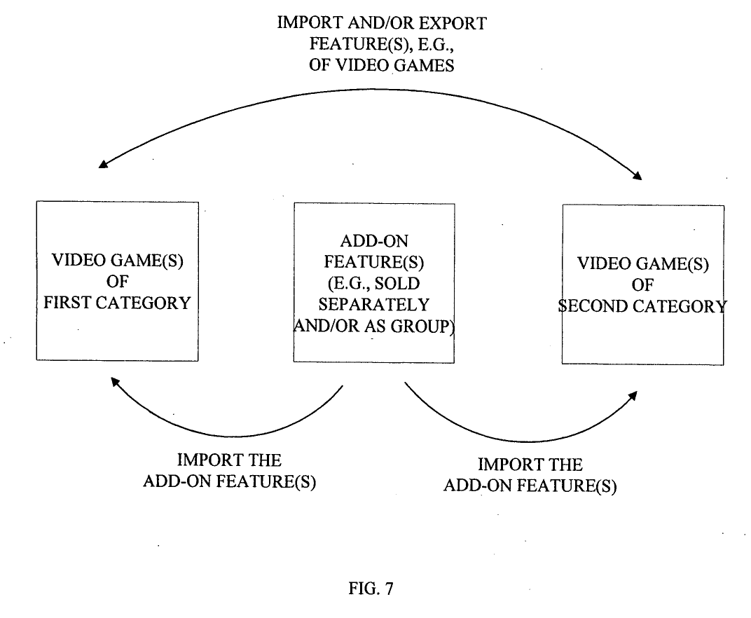

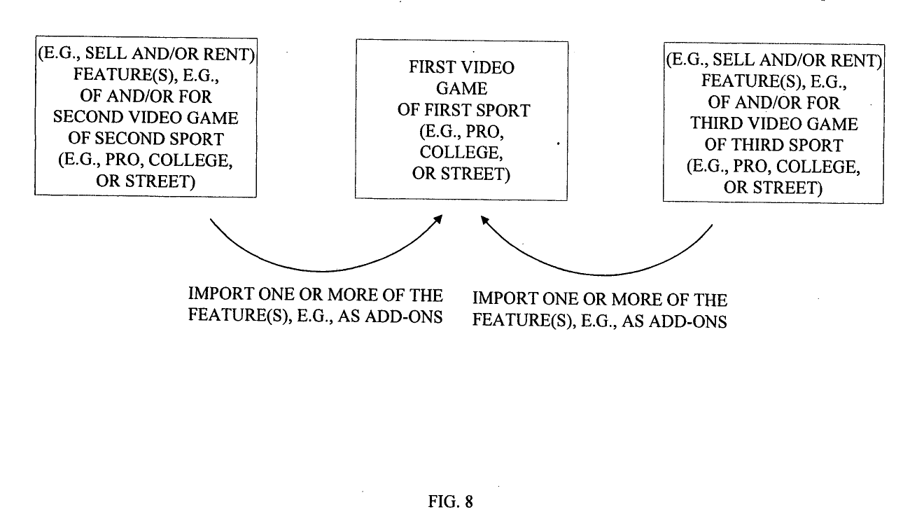

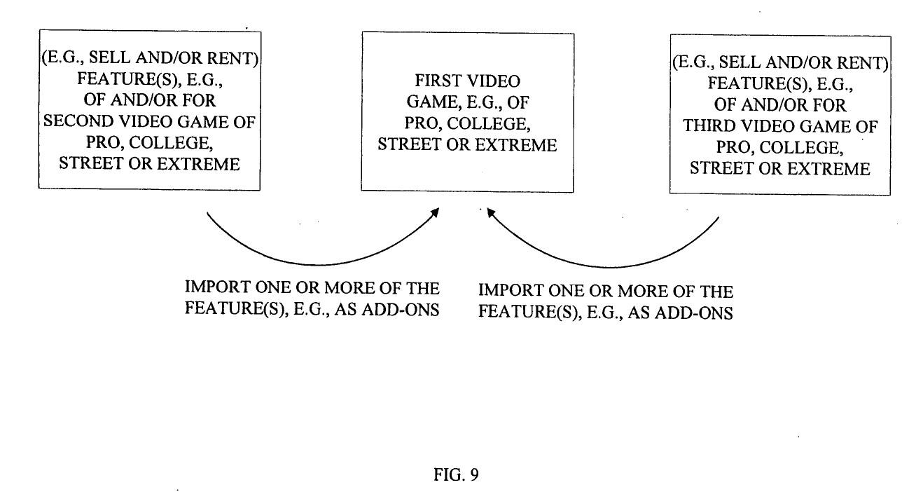

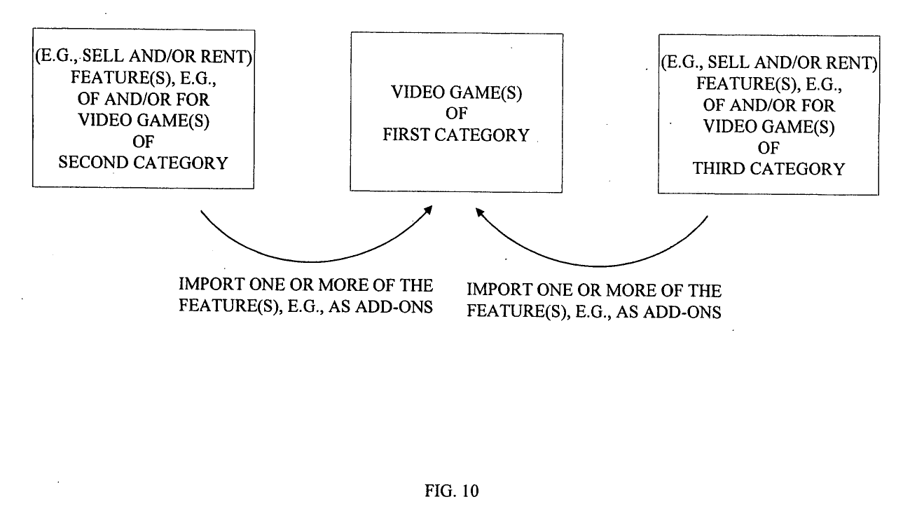

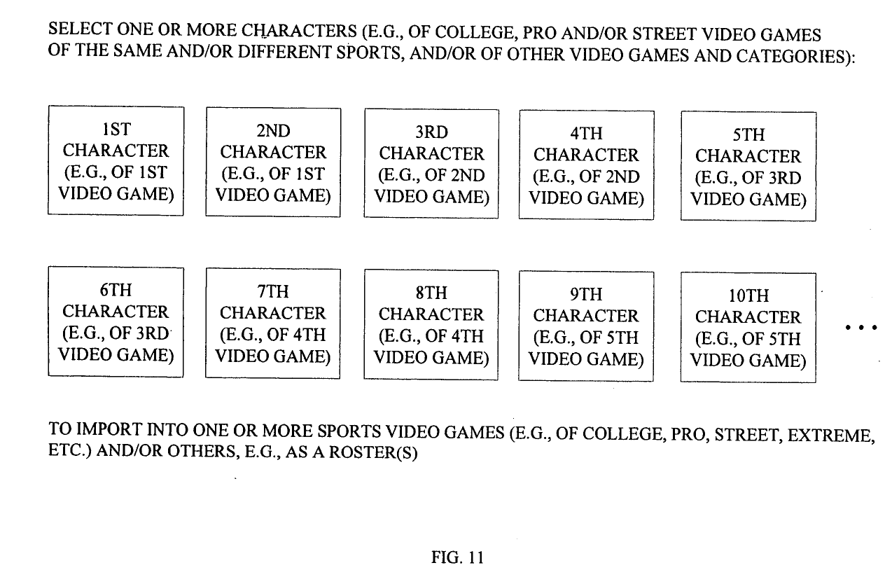

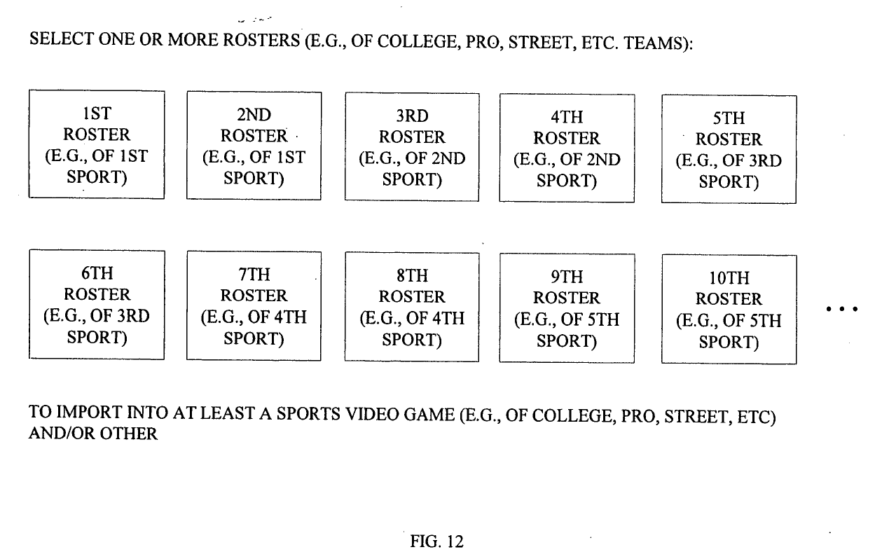

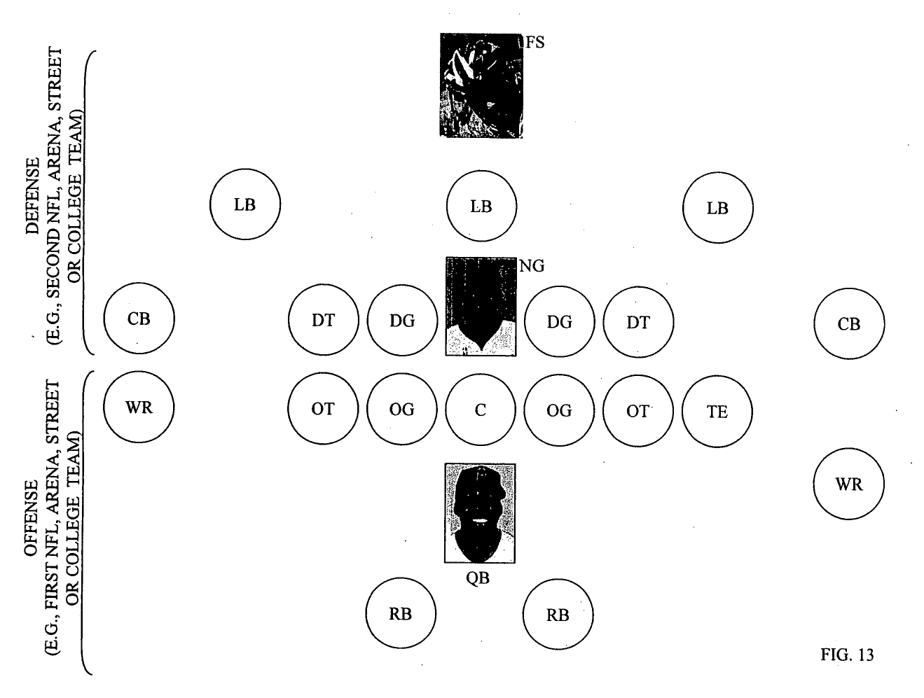

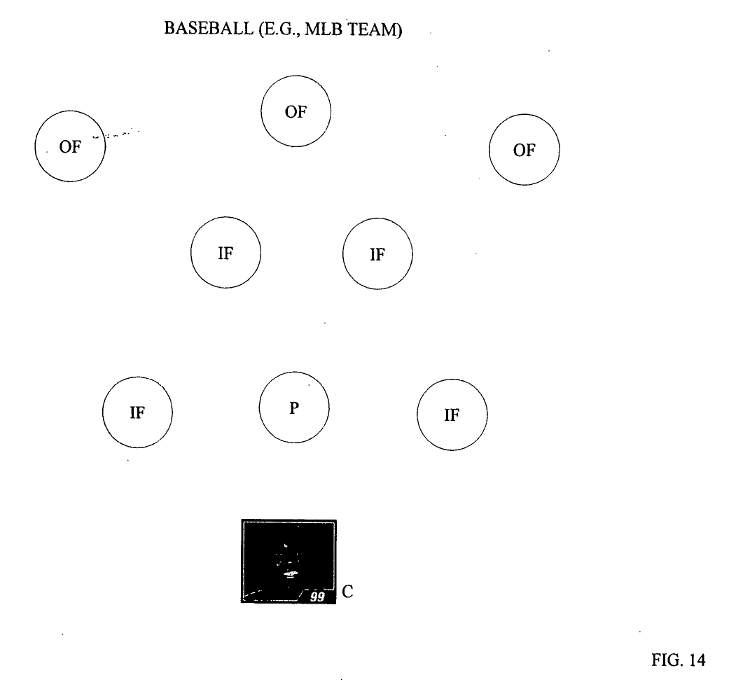

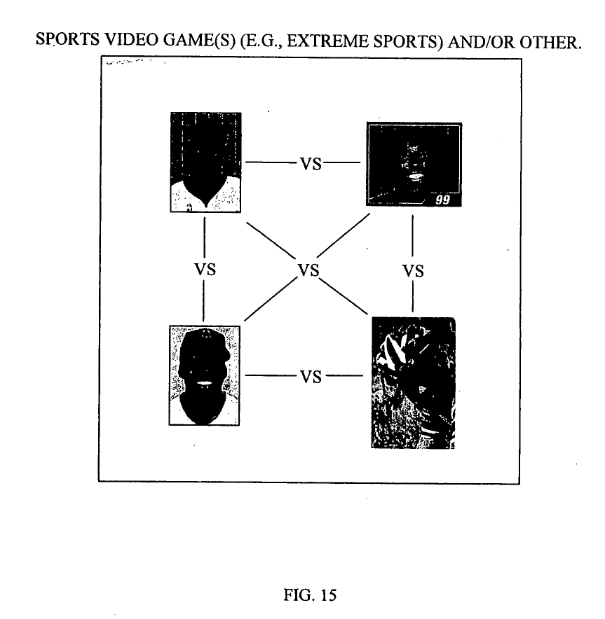

An exemplary combination of the method (see, for example, FIGS. 1-15) (which may or may not be used to raise funds, for example, for charity and/or other) may also include one or more of the following:
A method may provide at least a character(s) and/or other feature(s) of a first video game. The method may play a second video game with at least the character(s) and/or other feature(s) by importing the character(s) and/or other feature(s) (e.g., from the first video game) into the second video game. The first video game and the second video game may or may not be of different sports and/or different categories of video games. One of the first (e.g., sports) video game and the second (e.g., sports) video game may be one of (i) pro, (ii) college, (iii) street and (iv) extreme, and the other one of the first (e.g., sports) video game and the second (e.g., sports) video game may be a different one of (i) pro, (ii) college, (iii) street and (iv) extreme;
A method may provide a video game with a plurality of athletes and/or other features of different sports video games. The method may play the video game with one or more of the athletes and/or other features by at least selecting the one or more of the athletes and/or other features;
A method may provide a video game with a plurality of teams of different sports video games. The method may play the video game with one or more rosters of one or more of the teams by at least selecting the one or more of the teams;
A method may provide, through a video game, a pool including athletes, teams and/or other features (e.g., first features and second features) of different sports. The method may play, through the video game, a game with at least one or more of the athletes, teams and/or other features by at least selecting the one or more of the athletes, teams and/or other features from the pool. Each of the teams may include a roster and/or other feature. The method may add, through the video game, one or more of the athletes and/or other first features to one or more of the team rosters and/or other second features. The team rosters and/or other second features may be associated with a first sport, and the athletes and/or other first features may be associated with a second sport. The game may be the first sport or the second sport;
A method may provide, through a first video game, at least a first team roster and/or other features and, through a second video game, at least a second team roster and/or other features. The method may play, through the second video game, a game with at least the first team roster and/or other features and/or the second team roster and/or other features by importing the first team roster and/or other features (e.g., from the first video game) into the second video game. The first video game and the second video game may or may not be of different sports and/or leagues. One of the first team roster and the second team roster, for example, may be a team of a professional sports league (e.g., NFL Football, NBA Basketball, etc.), and the other one of the first team roster and the second team roster may be a team of an amateur sports league (e.g., NCAA Football, NBA Basketball). One of the first (e.g., sports) video game and the second (e.g., sports) video game may be one of (i) pro, (ii) college, (iii) street and (iv) extreme, and the other one of the first (e.g., sports) video game and the second (e.g., sports) video game may be a different one of (i) pro, (ii) college, (iii) street and (iv) extreme;
A method may provide, through a first video game, at least one or more pro athletes and/or other first features and, through a second video game, at least one or more amateur athletes and/or other second features. The method may play the second video game with at least the one or more pro athletes and/or other first features and/or the one or more amateur athletes and/or other second features by importing the one or more pro athletes and/or other first features (e.g., from the first video game) into the second video game. The first video game may be professional football and the second video game may be college football. The first video game may also be professional basketball and the second video game may also be college basketball;
A method may provide pro athletes and/or other first features of a first video game and amateur athletes and/or other second features of a second video game. The method may play the second video game with one or more of the pro athletes and/or other first features and/or one or more of the amateur athletes and/or other second features by importing the pro athletes and/or other first features (e.g., from the first video game) into the second video game. One of the first (e.g., sports) video game and the second (e.g., sports) video game may be one of (i) pro, (ii) college, (iii) street and (iv) extreme, and the other one of the first (e.g., sports) video game and the second (e.g., sports) video game may be a different one of (i) pro, (ii) college, (iii) street and (iv) extreme;
A method may provide, through a video game, a pool including athletes (e.g., pro, street, extreme and/or others) and college teams. The method may add, through the video game, one or more of the athletes (e.g., pro, street, extreme and/or others) to one or more of the college teams, for example, by using the pool. The method may play, through the video game, a game by using the one or more of the college teams;
A method may provide, through a first video game, at least one or more first characters and/or other features and, through a second video game, at least one or more second characters and/or other features. The method may play a third video game with at least one of (i) the one or more first characters and/or other features and (ii) the one or more second characters and/or other features by importing (i) the one or more first characters and/or other features (e.g., from the first video game) into the third video game and (ii) the one or more second characters and/or other features (e.g., from the second video game) into the third game. The first, second and/or third video games may be different games and/or categories. A first sports team roster may be made up of the one or more first characters and/or other characters, and a second sports team roster may be made up of the one or more second characters and/or other characters;
A method may provide a plurality of first athletes and/or other features of a first video game and a plurality of second athletes and/or other features of a second video game. The method may play a third video game with at least one of (i) one or more of the first athletes and/or other features and (ii) one or more of the second athletes and/or other features by importing at least (i) the one or more of the first athletes and/or other features into the third video game and (ii) the one or more of the second athletes and/or other features into the third game. Each of the first video game, the second video game and the third video game may be of different sports;
A method may provide, through a first video game, at least one or more characters and/or other features. The method may play a second video game with at least the one or more characters and/or other features by importing the one or more characters and/or other features (e.g., from the first video game) to the second video game. The first video game and the second video game may be of different categories and/or sports;
A method may display, through a store, information identifying at least a character, roster and/or other feature of a first video game to import into at least a second video game. The method may individually sell and/or rent, through the store, the character, roster and/or other feature, separate from the first video game and the second video game, to import into at least the second video game by at least charging on a per character, roster and/or feature basis. The store may be an online and/or offline store. The first video game may be of a first category of video games, and the second video game may be of a second category of video games, where the first category and the second category may be different categories. The first video game may also be of a first sport, and the second video game may be of a second sport, where the first sport and the second sport may be different sports;
A method may display information identifying at least a character, roster and/or other feature(s). The method may sell and/or rent the character, roster and/or other feature(s) itself to import into a first video game, and may separately sell and/or rent the character, roster and/or other feature(s) itself to import into a second video game, where the first video game and the second video game may have different game titles and be playable with the same platform. The method may provide (e.g., mail and/or download) the character, roster and/or other feature(s) to import into at least one of (i) the first video game and (ii) the second video game. The first video game and the second video game may be of different categories of video games. The first video game and the second video game may also be of different sports. One of the first (e.g., sports) video game and the second (e.g., sports) video game may be one of (i) pro, (ii) college, (iii) street and (iv) extreme, and the other one of the first (e.g., sports) video game and the second (e.g., sports) video game may also be one of (i) pro, (ii) college, (iii) street and (iv) extreme;
A method may display information identifying different athletes of video games of different sports. The method may send a request to order a roster(s) to import into one or more of the video games by at least selecting a plurality of the athletes for the roster. The method may fulfill the order for the roster(s) by at least receiving the request for the order. The video games of different sports, for example, may include (i) a football video game, (ii) a basketball video game and (iii) a baseball video game;
A method may display information identifying at least (i) a plurality of different characters, rosters and/or other features (e.g., and others) and (ii) a plurality of different video games (e.g., and others). The method may send a request to order at least one or more of the characters, rosters and/or other features to import into one or more of the video games by at least selecting (i) the one or more of the characters, rosters and/or other features and/or (ii) the one or more of the video games. The method may fulfill the order for the one or more of the characters, rosters and/or other features by at least receiving the request for the order. Each of the characters, rosters and/or other features may be of a first category of video games, and each of the video games may be of a second category of video games, where the first category and the second category may be different categories. Each of the characters, rosters and/or other features may also be of a first video game of a first sport, and the one or more of the video games may include a second video game of a second sport, where the first sport and the second sport may be different sports. The video games may further include different categories of video games;
A method may display information identifying at least a plurality of different characters, rosters and/or other features (e.g., and others) to import into a plurality of different video games (e.g., and others). The method may send a request to order one or more of the characters, rosters and/or other features by at least selecting (e.g., individually selecting) the one or more of the characters, rosters and/or other features from the plurality of different characters, rosters and/or other features. The method may fulfill the order for the one or more of the characters, rosters and/or other features to import into one or more of the video games by at least receiving the request for the order. The order may be fulfilled to complete a purchase, rental and/or trade for the one or more of the characters, rosters and/or other features to import into the one or more of the video games. The method may charge for the plurality of different characters, rosters and/or other features on a per character, roster and/or feature basis. The method may download and/or mail the one or more of the characters, rosters and/or other features to import into the one or more of the video games. Each of the plurality of different characters, rosters and/or other features may be of a first category of video games, and each of the plurality of different video games may be of a second category of video games, where the first category and the second category may be different categories. Each of the plurality of different characters, rosters and/or other features may also be of a first video game of a first sport, and the one or more of the video games may include a second video game of a second sport, where the first sport and the second sport may be different sports. The plurality of different characters, rosters and/or other features may further be of (i) different categories of video games and/or (ii) video games of different sports;
A method may display information identifying at least (i) a first character and/or other feature and (ii) a second character and/or other feature. The method may sell, rent and/or trade for the first character and/or other feature itself to import into a video game, and separately sell, rent and/or trade for the second character and/or other feature itself to import into the video game. The first character and/or other feature and the second character and/or other feature may be different characters and/or other features. The method may charge for the first and second characters and/or other features on a per character and/or feature basis. The method may download and/or mail the first character and/or other feature and/or the second character and/or other feature to import into the video game. The first character and/or other feature may be of a first category of video games, and the second character and/or other feature may be of a second category of video games, where the first category and the second category may be different categories. The first character and/or other feature may also be of a first sport, and the second character and/or other feature may be of a second sport, where the first sport and the second sport may be different sports. The different characters and/or other features may be of different video games. The different characters and/or other features may be of a second video game, where the first-mentioned video game and the second video game may be different video games;
A method may display information identifying at least (i) a first roster and/or other feature and (ii) a second roster and/or other feature. The method may sell, rent and/or trade for the individual first roster and/or other feature to import into a video game, and separately sell, rent and/or trade for the individual second roster and/or other feature to import into the video game. The first roster and/or other feature and the second roster and/or other feature may be different rosters and/or other feature. The method may charge for the first and second rosters and/or other features on a per roster and/or feature basis. The method may download and/or mail the first roster and/or other feature and/or the second roster and/or other feature to import into the video game. The first roster and/or other feature may be of a first category of video games, and the second roster and/or other feature may be of a second category of video games, where the first category and the second category may be different categories. The first roster and/or other feature may also be of a first sport, and the second roster and/or other feature may be of a second sport, where the first sport and the second sport may be different sports. The different rosters and/or other features may be of different video games. The different rosters and/or other features may be of a second video game, where the first-mentioned video game and the second video game may be different video games;
A method may display, through a store, information identifying at least an add-on feature. The method may raise funds for charity (e.g., one or more not-for-profit and/or other charitable organizations), for example, by at least selling and/or renting, through the store, the add-on feature to import into at least a video game. The add-on feature may include (i) a character (e.g., of a public figure), (ii) a roster of a sports team and/or (iii) a plurality of athletes of different sports teams of a sports league. The charity may be selected, in part or in whole, by (i) the public figure (e.g., a professional athlete), (ii) the sports team and/or (iii) the sports league. The feature may be associated with a first sport and the video game may be of a second sport (e.g., or of another sport), where the first sport and the second sport may be different sports. The add-on feature may also include a first character and a second character. The first character may be of the first sport and the second character may be of the second sport. The first character may also be of a first category of video games and the second character may be of a second category of video games, where the first category and the second category may be different categories. The video game may be of the second category (e.g., or of another category);
A method may provide a plurality of different sports video games including, in combination, a plurality of different athletes. The method may allow one or more gamers to play each of the plurality of different sports video games with the plurality of different athletes, for example, to determine who is the best athlete (e.g., in the world) and/or who is not. An athlete that, for example, dominates in each of the plurality of different sports may be deemed the best. The plurality of different sports video games may include, for example, a baseball video game, a basketball video game, a boxing video game, a football video game, a golf video game, a hockey video game, a racing video game, a soccer video game and/or others. The plurality of different athletes may include, for example, an athlete of a baseball video game, an athlete of a basketball video game, an athlete of a boxing video game, an athlete of a football video game, an athlete of a golf video game, an athlete of a hockey video game, an athlete of a racing video game, an athlete of a soccer video game and/or others; and/or
A method may provide a plurality of different sports video games including, in combination, a plurality of different team rosters. The method may allow one or more gamers to play each of the plurality of different sports video games with the plurality of different rosters, for example, to determine who is the best team (e.g., in the world) and/or who is not. A team that, for example, dominates in each of the plurality of different sports may be deemed the best. The plurality of different sports video games may include, for example, a baseball video game, a basketball video game, a boxing video game, a football video game, a golf video game, a hockey video game, a racing video game, a soccer video game and/or others. The plurality of different team rosters may include, for example, a team roster of a baseball video game, a team roster of a basketball video game, a team roster of a football video game, a team roster of a hockey video game, a team roster of a soccer video game and/or others.

The sport(s) and/or video game(s) such as, for example, the first sport and/or video game may be: football, basketball, baseball, boxing, wrestling, martial arts, skateboarding, snowboarding, surfing, rock climbing, skiing, ski jumping, bobsledding, luge, extreme sports, water sports, soccer, hockey, rugby, cricket, lacrosse, volleyball, tennis, golf, auto racing, motor sports, track and field, gymnastics, water polo, swimming, speed skating, ice skating, roller skating, diving, rowing, archery, kayak, olympic sports, table tennis, cycling, weight-lifting, water skiing, fishing, shooting, bowling, horse racing, billiards, rodeo, cheerleading and/or poker, and the second sport and/or video game and/or the third sport and/or video game (e.g., and others) may be a different one. The sports and/or video games may also be any other known sport and/or game. One or more of the sports and/or sports video game(s) (e.g., first, second and/or third video games) may fall under pro, amateur (e.g., college), street, etc. such as, for example, Electronic Arts' Madden NFL, NCAA Football, NFL Street, NBA Live, NBA Street, NCAA March Madness, etc.

The feature(s) (e.g., the other feature(s), add-on feature(s), etc.) may be (1) features of and/or (2) add-on features for one or more video games (e.g., of one or more different sports and/or categories). The feature(s) may include character(s) (e.g., athlete(s)) and/or roster(s). The feature(s) may also include venues, equipment, accessories, clothes (e.g., uniforms), vehicles (e.g., cars), plays, music (e.g., songs), etc.

The feature(s) (e.g., characters(s) and/or roster(s)) and the pool (e.g., a list, a group, etc.) including the characters (s), roster(s) and/or other feature(s) may be associated with football, basketball, baseball, boxing, wrestling, martial arts, skateboarding, snowboarding, surfing, rock climbing, skiing, ski jumping, bobsledding, luge, extreme sports, water sports, soccer, hockey, rugby, cricket, lacrosse, volleyball, tennis, golf, auto racing, motor sports, track and field, gymnastics, water polo, swimming, speed skating, ice skating, roller skating, diving, rowing, archery, kayak, olympic sports, table tennis, cycling, weight-lifting, water skiing, bowling, horse racing and/or rodeo. The character(s), roster(s), other feature(s) and/or pool, for example, may include and/or be associated with (i) a plurality of active NFL All-Pro players, (ii) a plurality of active NBA All-Star players and/or (iii) a plurality of active MLB All-Star players. The character(s), roster(s), other feature(s) and/or pool may also include and/or be associated with (i) a plurality of retired NFL All-Pro players, (ii) a plurality of retired NBA All-Star players and/or (iii) a plurality of retired MLB All-Star players. The character(s), roster(s), other feature(s) and/or pool may further include and/or be associated with some and/or all NFL, NBA, MLB, PGA, NHL, MLS, NASCAR and/or NCAA players (e.g., active and/or retired), rosters and/or teams.

The one or more characters (e.g., athletes and/or others), team rosters and/or other features may be selected from the pool, for example, by (i) scrolling through the pool, (ii) highlighting the one or more characters, teams and/or other features and (iii) pressing a button of a controller. The one or more characters and/or other features, for example, may be selected from the pool to be added to a roster. Also, the one or more characters (e.g., athletes and/or others), team rosters and/or other features may be imported, through a machine-readable-medium (e.g., memory card), into the second video game and/or others, for example, as it is known to import an entire draft class from Electronic Arts' NCAA Football to Madden NFL Football via a memory card. The method may provide a draft for the one or more characters and/or other features. The method may also allow roster moves such as, for example, trade players, sign players, and/or release players to be made to strengthen a lineup. Injuries and/or demands by the one or more athletes from one sport (e.g., the first video game) may be carried forward to another sport (e.g., the second video game).

The character(s), for example, may include one or more athletes, coaches, managers, team owners, sports agents, promoters, announcers, commentators, icons, stars (e.g., movie stars, television stars, rock stars and/or others), superheroes, cartoon characters, animated characters, action figures, actors, politicians, musicians, entertainers, celebrities, comedians, and/or business people. The character(s), for example, may also include (i) public and/or private figures, (ii) pop icons and/or (iii) famous, infamous and/or ordinary people. The character(s) may resemble (e.g., physically and/or emotionally) their real world counterparts. The character(s) may include video game characters such as, for example, Ben Rothlisberger (of Madden NFL Football), Psymon (of SSX Tricky), Nick Kang (of True Crime), Raiden (of Mortal Kombat) and/or SpongeBob (of SpongeBob).

The one or more athletes and/or team rosters may include professional, amateur and/or fictional athletes, which may be active and/or retired. The athletes may also be single-sport or multi-sport athletes. The team rosters may be associated with (e.g., be a part of) professional, amateur and/or fictional sports leagues such as, for example, NFL, NBA, MLB, NHL, MLS and/or NCAA. The athletes and/or team rosters may include Lou Gehrig, Gordie Howe, Michael Jordan, Jackie Robinson, Rafer Johnson, Wilt Chamberlain, Bo Jackson, Dave Winfield, Jim Thorpe, Jim Brown, Muhammad Ali, Pele, Lance Armstrong, Andre Agassi, Randy Johnson, Shaquille O'Neal, Vladimir Guerrero, LeBron James, Warren Sapp, Andy Roddick, David Beckham, Tracy McGrady, Michael Vick, Kevin Garnett, Kobe Bryant, Tim Montgomery, Simeon Rice, Ray Lewis, Tony Gonzalez, Peter Forsberg, Tiger Woods, Tony Hawk, Artus Taymazov, Michael Phelps, Kelly Slater, Freddy Adu, Jonny Wilkinson, Paul Hamm, Thierry Henry, Allen Iverson, Terrell Owens, Jason Kidd, Brian Urlacher, Alex Rodriguez, Ichiro Suzuki, Sergei Fedorov, Barry Bonds, Roger Federer, Zinedine Zidane, Tim DeBoom, Jeremy Bloom, Roy Jones Jr., Peter Reid and/or Tom Pappas, e.g., all of which have been considered as top athletes.

A performance of the one or more characters (e.g., athletes) and/or team rosters may be enhanced to play a game by putting the one or more characters and/or team rosters through one or more drills and/or pre-season games. The drills may include performing certain plays, runs, and/or passes, and may be part of a training camp.

The general categories of video games may include simulations of sports, simulations of military actions, games inspired by cinema, electronic versions of traditional games (e.g. cards), simulations of actions in the framework of a certain profession (e.g. physician), and specific games not appealing to reality. The categories of video games, for example, may include action, adventure, children's, driving (e.g., racing), fighting, first person (e.g., shooting), puzzle, role-playing, simulation, sports, strategy and/or card/casino games.

An exemplary embodiment of the method (e.g., a service) may allow users to search, preview, buy, download and/or recommend at least individual characters, rosters and/or other features (e.g., of video games and/or others) to import into one or more video games. The method may allow the users to browse by and/or enter a search for at least (i) video game categories, (ii) video game titles and/or (iii) characters, rosters and/or other features. The method may provide previews of items, for example, by double-click on listings. The method may provide the users a shopping cart to hold their selections until the users are ready to buy. The method may allow users to buy at least individual characters, rosters and/or other features, for example, with just one click. (See, for example, U.S. Pat. No. 5,960,411, which is hereby incorporated by reference.) The method may provide (e.g., mail and/or download) the selected characters, rosters and/or other features (e.g., via a machine-readable-medium such as, for example, a memory card) to import into the one or more video games.

The method may also determine a user's interests by examining, in part or in whole, the items (e.g., video games, characters, rosters and/or other features) purchased, items the user has indicated he or she owns, and/or items the user has rated. The method may compare the user's activity on a site of the service with that of other customers. Using this comparison, the method may recommend other items (e.g., video games, characters, rosters and/or other features) that may interest the user. The recommendations may change when the user purchases or rates a new item. Changes in the interests of other customers may also affect the user's own recommendations. (See, for example, U.S. Pat. No. 6,853,982, which is hereby incorporated by reference.)

When rating an item (e.g., video games, characters, rosters and/or other features), the method may provide a star scale, for example, as follows: 1 star: I hate it; 2 stars: I don't like it; 3 stars: It's OK; 4 stars: I like it; and 5 stars: I love it. These ratings may be used by the recommendations service to provide the user more accurate recommendations.

The service (e.g., an online and/or offline service) may thus sell, rent and/or trade individual video games, characters (e.g., of video games and/or others), rosters (e.g., of sports teams and/or others) and/or other features, and may charge a monthly fee and/or charge on a per item basis such as, for example, pay for what you buy and/or rent, and no more.

One exemplary embodiment of the service may allow users to place an order for at least individual items (e.g., video games, characters, rosters and/or other features, for example, as described above) as follows:

1. Find the Items You Want;

2. Add the Items to Your Shopping Cart;

3. Proceed to Checkout;

4. Sign In;

5. Enter a Shipping Address;

6. Choose a Shipping Method;

7. Provide a Password and Payment Information;

8. Review and Submit Your Order; and/or

9. Check Your Order Status,

Find the Items You Want

You may browse or search for the items you would like to order. When you find an item that interests you, click the title or name of the item to see its product detail and/or preview page. Here you will find more information about the item, including an availability estimate of how long it will take before the item will be ready to be shipped and/or downloaded.

Add the Items to Your Shopping Cart

If you want to order an item, click the “Add to Shopping Cart” button on the item's product detail page. Once you've added an item to your Shopping Cart, use the cart's navigation bar or the “Continue shopping” button to keep searching or browsing until your cart contains all of the items you want to order. You can access the contents of your Shopping Cart at any time by clicking the Shopping Cart icon at the Web site.

Proceed to Checkout

You may review all of the items placed in your Shopping Cart. If you decide that you don't want to purchase a particular item right away, click the “save for later” button. The item will move from your current Shopping Cart to the “Saved Items—To Buy Later” list. When you're ready to place an order for everything in the “Shopping Cart Items—To Buy Now” section of your cart, click the “Proceed to checkout” button. You will be taken to the first page of the order form.

The instructions for an online order form may include:

Sign in

Enter your e-mail address, indicate that you are a new customer, and click the “Sign in” button. You may be asked to provide a password for your account later in the process.

Enter a Shipping Address

Tell us where you would like to ship your order, and let us know if any of the items are to be gifts. If so, you'll be given a chance to order gift-wrap and add a note.

Choose a Shipping Method

Consider how quickly you would like to receive your order, and choose a shipping method.

We will estimate shipment dates for you on the order form, just before you submit your order. You will see estimated shipment and delivery dates in an e-mail we send you to confirm your order.

If there is more than one item in your order, you may be given the following options:
Group my items into as few shipments as possible
I want my items faster. Ship them as soon as they become available (e.g., at additional cost)

If you choose the first option, we'll consolidate your items into the fewest shipments possible. We'll show you the minimum number of shipments needed to complete your order. If you choose the second option, we will ship items to you as they become available, beginning with those already in stock. You'll be charged a per-shipment fee for each shipment.

The shipping charge for your order will be displayed on the order summary page just before you submit your order.

Provide a Password and Payment Information

Choose a password for your account so that when you come back to the web site in the future, you can use the same shipping address and method of payment you provided during this first order. You will also be able to use your password to make changes to your order and account information.

Next, let us know how you would like to pay for your order.

Review and Submit Your Order

Check the accuracy all of the information you provided and make any necessary adjustments. When you are ready, click the Place Your Order button to submit your order. Once you place your order, we will send you a confirmation e-mail message. We will send you another e-mail message at the time of shipment. We may also turn 1-Click shopping on for you so that it's even easier to order in the future.

Check Your Order Status

If you would like to review or change something about the order you placed before it enters the shipping process, click the Your Account link in the site. Here you will be able to change the particulars of your order.

The feature(s) and/or video game(s) (e.g., of one or more described embodiments) may be playable by consumers on platforms including personal computers and/or entertainment systems (e.g., consoles, television and/or handhelds) such as, for example, Sony PlayStation2, Sony PlayStation, Microsoft Xbox, Nintendo GameCube, Game Boy Advance and/or N-Gage. The platforms may also include online, over the Internet and/or other online networks. The handhelds may include cell phones.

A user may download the feature(s) such as, for example, characters and/or rosters. The user, for example, may use X-Port, SharkPort and Action Replay as sold at retail or game specialty stores to download. The user may also select a memory card with characters, rosters and/or other features to be mailed.

Unlike buying a video game, where garners would have to pay for the whole video game to get the one or two characters, rosters and/or other features they really want, an embodiment of the method may allow garners to buy only the characters, rosters and/or other features they like and want to own, so as to import into one or more other video games. The method may also allow garners to (i) buy characters, rosters and/or other features that, for example, video games themselves do not include and/or (ii) mix and match characters, rosters and/or other features, for example, of different video game titles, video game categories and/or sports.

A machine-readable medium having encoded information, which when read and executed by a machine causes, for example, a method (e.g., one or more described embodiments). The machine-readable medium may store programmable parameters and may also store information including executable instructions, non-programmable parameters, and/or other data. The machine-readable medium may comprise read-only memory (ROM), random-access memory (RAM), nonvolatile memory, an optical disk, a magnetic tape, and/or magnetic disk. The machine-readable medium may further include, for example, a carrier wave modulated, or otherwise manipulated, to convey instructions that can be read, demodulated/decoded and executed by the machine (e.g., one or more of the platforms). The machine may comprise one or more microprocessors, microcontrollers, and/or other arrays of logic elements.

In view of the foregoing, it will be apparent to one of ordinary skill in the art that the described embodiments may be implemented in software, firmware, and/or hardware. The actual software code or specialized control hardware used to implement the described embodiments is not limiting of the invention. Thus, the operation and behavior of the embodiments is described without specific reference to the actual software code or specialized hardware components. The absence of such specific references is feasible because it is clearly understood that artisans of ordinary skill would be able to design software and/or control hardware to implement the embodiments based on the description herein.

The foregoing presentation of the described embodiments is provided to enable any person skilled in the art to make or use the present invention. Various modifications to these embodiments are possible, and the generic principles presented herein may be applied to other embodiments as well. As such, the present invention is not intended to be limited to the embodiments shown above, any particular sequence of acts, and/or any particular configuration of hardware but rather is to be accorded the widest scope consistent with the principles and features disclosed in any fashion herein.

What is claimed is:

1. A method comprising:
displaying, through a store, information identifying at least an add-on feature; and
raising funds for charity by at least selling and/or renting, through the store, the add-on feature to import into at least a video game.

2. The method of claim 1, wherein the add-on feature is a character of a public figure.

3. The method of claim 2, wherein the charity is selected, in part or in whole, by the public figure.

4. The method of claim 2,
wherein the public figure is a professional athlete of a first sport,
wherein the video game is of a second sport, and
wherein the first sport and the second sport are different sports.

5. The method of claim 1, wherein the add-on feature is at least a roster of a sports team.

6. The method of claim 5, wherein the charity is selected, in part or in whole, by the sports team.

7. The method of claim 5,
wherein the sports team is of a first sport,
wherein the video game is of a second sport, and
wherein the first sport and the second sport are different sports.

8. The method of claim 1, wherein the add-on feature includes a plurality of athletes of different sports teams of a sports league.

9. The method of claim 8, wherein the charity is selected, in part or in whole, by the sports league.

10. The method of claim 8,
wherein the sports league is of a first sport,
wherein the video game is of a second sport, and
wherein the first sport and the second sport are different sports.

11. The method of claim 1,
wherein the add-on feature includes a first professional athlete and a second professional athlete,
wherein the first professional athlete is of a first sport,
wherein the second professional athlete is of a second sport, and
wherein the first sport and the second sport are different sports.

12. The method of claim 1,
wherein the add-on feature includes a first character and a second character,
wherein the first character is associated with a first category of video games,
wherein the second character is associated with a second category of video games, and
wherein the first category and the second category are different categories.

13. A method comprising:
providing a plurality of different sports video games including, in combination, a plurality of different athletes; and
determining who is the best athlete by at least allowing one or more gamers to play each of the plurality of different sports video games with the plurality of different athletes.

14. The method of claim 13, wherein the plurality of different sports video games include a baseball video game, a basketball video game, a boxing video game, a football video game, a golf video game, a hockey video game, a racing video game, and a soccer video game.

15. The method of claim 13, wherein the plurality of different athletes include an athlete of a baseball video game, an athlete of a basketball video game, an athlete of a boxing video game, an athlete of a football video game, an athlete of a golf video game, an athlete of a hockey video game, an athlete of a racing video game, and an athlete of a soccer video game.

16. A method comprising:
providing a plurality of different sports video games including, in combination, a plurality of different team rosters; and
determining who is the best team by at least allowing one or more gamers to play each of the plurality of different sports video games with the plurality of different rosters.

17. The method of claim 16, wherein the plurality of different sports video games include a baseball video game, a basketball video game, a boxing video game, a football video game, a golf video game, a hockey video game, a racing video game, and a soccer video game.

18. The method of claim 16, wherein the plurality of different team rosters include a team roster of a baseball video game, a team roster of a basketball video game, a team roster of a football video game, a team roster of a hockey video game, and a team roster of a soccer video game.
